(19) United States
(12) Patent Application Publication
(10) Pub. No.: US 2026/0147128 A1
(43) Pub. Date: May 28, 2026

(54) Method and System for Determining Energy Deposited in a Scintillator Using Per-Photon Wavelength Information

(71) Applicant: Andrey Elagin, BOLINGBROOK, IL (US)

(72) Inventor: Andrey Elagin, BOLINGBROOK, IL (US)

(21) Appl. No.: 19/396,211

(22) Filed: Nov. 20, 2025

Related U.S. Application Data
(60) Provisional application No. 63/833,381, filed on Nov. 25, 2024.

(51) Int. Cl. G01T 7/00; G01T 1/20

(52) U.S. Cl. CPC G01T 7/005; G01T 1/20184

(57) ABSTRACT

A method and system for determining energy deposited in a scintillator detector are provided. Photons generated by an energy deposition event are detected by wavelength-resolving photodetectors, and individual photon wavelengths are recorded to form an observed spectral response. Calibrated and simulated spectral responses are generated and combined into a reference schema. An observed spectral response of an event being measured is analyzed against the schema to infer deposited energy. Timing and positional information of detected photons may also be recorded and used for auxiliary corrections. The invention is compatible with emerging wavelength-resolving photodetectors currently under development.

### CROSS-REFERENCE TO RELATED APPLICATIONS

This application claims the benefit of U.S. Provisional Patent Application No. 63/833,381, filed Nov. 25, 2024, entitled “Methods of Measuring Energy Deposited in a Scintillation Medium Using Information about Wavelengths of Individual Photons Detected in Association with the Energy Deposition.” The entire contents of that provisional application are incorporated herein by reference in their entirety. Priority is claimed under 35 U.S.C. § 119(e).

### BACKGROUND OF THE INVENTION

### 1. Field of the Invention

The invention relates to scintillator-based radiation detectors, and more particularly to methods and systems for determining deposited energy in a scintillator by analyzing the spectral distribution of detected scintillation photons. In this approach, individual photons are detected and recorded, and their wavelengths are used to construct an event-specific spectral response. Photon counting is preserved, but it is performed with spectral discrimination consistent with the experimentally achieved wavelength resolution, enabling energy estimation based not only on total photon yield but also on the detailed spectral shape. In practical experimental settings, the spectral shape itself is event specific and may vary depending on the conditions of the interaction.

### 2. Description of Related Art

Scintillator detectors are widely used in radiation measurement, including nuclear physics experiments, positron emission tomography (PET), high-energy physics, and homeland security applications. A particle interacting with a scintillator material generates scintillation photons, with a possible admixture of photons from Cherenkov emission, fluorescence, re-emission, or similar optical processes. These photons are then detected by photodetectors such as photomultiplier tubes (PMTs) or silicon photomultipliers (SiPMs), although other photon-sensitive devices may be used.

Conventional approaches to energy reconstruction rely primarily on the total number of detected photons or the integrated charge collected by the photodetectors. Timing and positional information of photon detections is also commonly recorded to refine event localization, depth-of-interaction, and time-of-flight calculations. However, per-photon wavelength is typically not measured or used for energy estimation in scintillator-based systems.

### PRIOR ART REFERENCES

1. Knoll, G. F., Radiation Detection and Measurement, 4th ed., Wiley, 2010.
2. Dorenbos, P., et al., “Fundamental limitations in the performance of Ce³⁺-, Pr³⁺-, and Eu²⁺-activated scintillators,” IEEE Transactions on Nuclear Science, 42(6), 1995.
3. Brunner, S., et al., “Separation of scintillation and Cherenkov light in high-energy physics detectors,” JINST, 2014.
4. Levin et al., U.S. Pat. No. 9,141,727.
5. Moses et al., U.S. Pat. No. 7,923,743.
6. Agostinelli, S., et al., “GEANT 4—a simulation toolkit,” Nuclear Instruments and Methods in Physics Research A, 506, 2003.
7. Böhlen, T. T., et al., “The FLUKA code: developments and challenges for high energy and medical applications,” Nuclear Data Sheets, 120, 2014.
8. Pelowitz, D. B., et al., MCNP6 User's Manual, Los Alamos National Laboratory, LA-CP-13-00634, 2013.
9. Young, S. M., Sarovar, M., & Léonard, F., “Nanoscale architecture for frequency-resolving single-photon detectors,” Communications Physics, vol. 6, Article 71, 2023.
10. Bocchieri, A., et al., “Scintillation event imaging with a single-photon avalanche diode camera,” Nature Communications Physics, 2024.
11. Min, S., et al., “End-to-end design of multicolor scintillators for enhanced X-ray imaging,” Light: Science & Applications, 2025.
12. C. Aberle et al., “Measuring directionality in double beta-decay and neutrino interactions in a large liquid scintillator detector,” JINST 9, P06012 (2014).
13. Frisch et al., “Positron emission tomography systems based on ionization-activated organic fluor molecules, planar pixelated photodetectors, or both,” WO2022093732A1 (2022).
14. A. Elagin et al., “Separating double-beta decay events from solar neutrino interactions in a kiloton-scale liquid scintillator detector by fast timing,” Nucl. Instrum. Meth. A849, 102-111 (2017).
15. R. Jiang and A. Elagin, “Space-Time Discriminant to Separate Double-Beta Decay from ⁸B Solar Neutrinos in Liquid Scintillator,” arXiv:1902.06912 (2019).
16. J. Gruszko et al., “Detecting Cherenkov light from 1-2 MeV electrons in linear alkylbenzene,” JINST 14, P02005 (2019).
17. J. Caravaca et al., “Characterization of water-based liquid scintillator for Cherenkov and scintillation separation,” Eur. Phys. J. C 80, 867 (2020).
18. A. Li et al., “Suppression of cosmic muon spallation backgrounds in liquid scintillator detectors using convolutional neural networks,” Nucl. Instrum. Meth. A947, 162604 (2019).
19. J. F. Shida et al., “Low-dose high-resolution TOF-PET using ionization-activated multi-state low-Z medium,” Nucl. Instrum. Meth. A1017, 165801 (2021).
20. K. Domurat-Sousa and C. Poe, “Simulation of a low-Z-medium detector for low-dose high-resolution TOF-PET,” Nucl. Instrum. Meth. A1057, 168675 (2023).
21. T. Kaptanoglu et al., “Cherenkov and scintillation light separation using wavelength in LAB-based liquid scintillator,” Journal of Instrumentation (JINST) 14, T05001 (2019).
22. T. Kaptanoglu et al., “Spectral photon sorting for large-scale Cherenkov and scintillation detectors,” Physical Review D 101, 072002 (2020).
23. A. Bacon et al., “Dichroic filter characterizations,” arXiv:2505.10702 (2025).

The references listed above illustrate prior or ongoing work in the general area of scintillator and optical detector development. They are provided to assist understanding of the field, and their inclusion does not constitute an admission that any such reference is prior art with respect to the present invention.

### SUMMARY OF THE INVENTION

The invention provides a method and system for improved energy reconstruction in scintillation detectors by incorporating per-photon wavelength information into the estimation of deposited energy.

Unlike conventional photon-counting methods, which may include timing and positional corrections, the invention records and analyzes the wavelength of each detected photon to construct an event-specific spectral response. This spectral response is compared to a set of calibrated and simulated reference responses to infer deposited energy.

Key features include:
1. Per-photon wavelength measurement during energy deposition events.
2. Construction of calibrated spectral responses using known sources.
3. Generation of simulated spectral responses with Monte Carlo models, adjusted to agree with calibration.
4. Assembly of a reference schema of spectral responses.
5. Event-by-event comparison of observed spectra against the schema to infer deposited energy.

Timing and positional information may also be recorded and, where available, can be used for auxiliary corrections as is standard in the art; however, the novelty of the invention resides in incorporating per-photon wavelength distributions into the energy determination process.

### BRIEF DESCRIPTION OF THE DRAWINGS

FIG. 1 is a schematic diagram of a scintillation detection system. A scintillation medium (1) emits light in response to an energy deposition event (2). The scintillation medium may be enclosed within an optional transparent container (3). A plurality of photodetectors (4) are arranged around the scintillation region to detect emitted photons, and signals from the photodetectors are processed by a data acquisition (DAQ) unit (5).

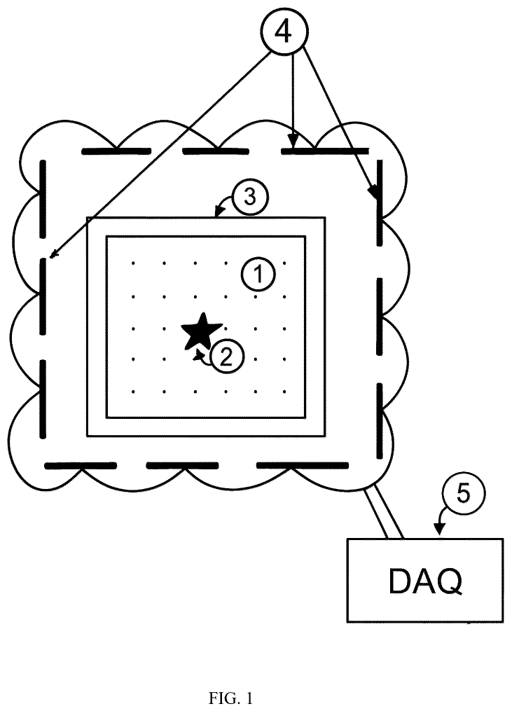

FIG. 2 is a block diagram illustrating an example data processing workflow. The system includes calibration, simulation, data acquisition, and reconstruction stages arranged sequentially. Reconstruction results may provide feedback to both the calibration and simulation stages, enabling iterative refinement of system models, detector parameters, and data interpretation. The order and interaction of these steps can vary depending on the implementation and application.

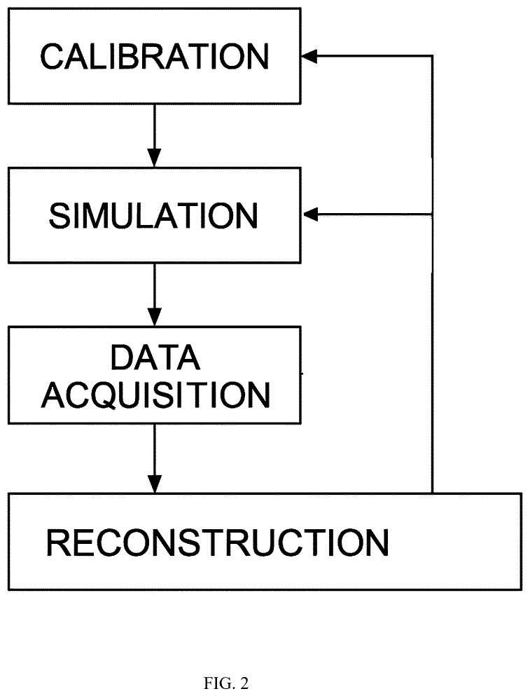

FIG. 3 is a plot illustrating a characteristic spectral distribution used for calibration. The curve (6) shows the number of photons as a function of wavelength. The specific shape and position of the peak are illustrative and not limiting, and the method is applicable over a wide range of materials and wavelengths.

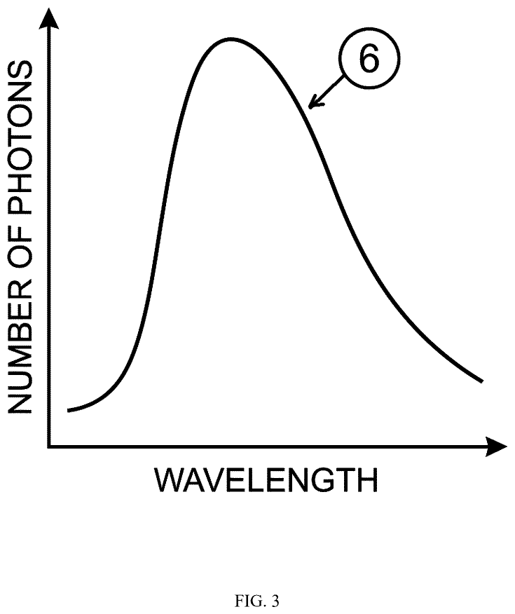

FIG. 4 is a schematic diagram illustrating an example of energy reconstruction through spectral comparison. A measured spectrum (7) is compared to a plurality of reference spectra (8), each corresponding to known conditions and/or energies. By analyzing the relationship between the measured data and the ensemble of reference spectra, the system determines a reconstructed energy value (9). This approach enables accurate event characterization by leveraging per-photon spectral information from a pre-established reference library.

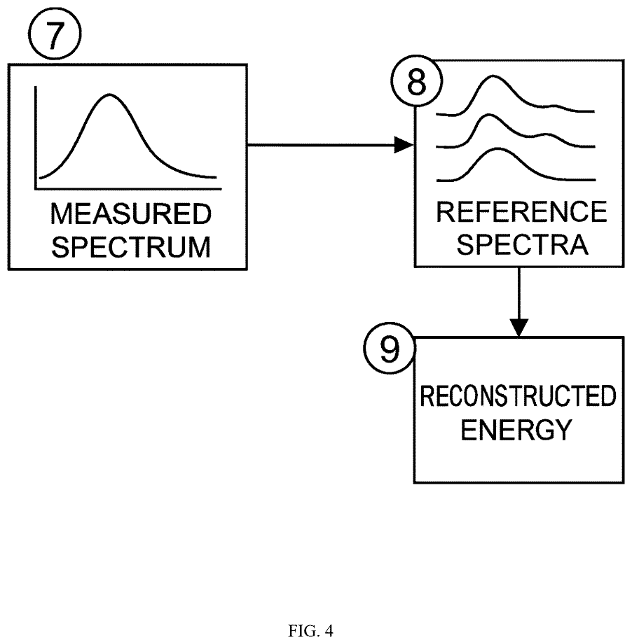

FIG. 5 is a plot illustrating the dependence of energy resolution on reconstructed (deposited) energy for a scintillation detection system. The curve (10) shows how the fractional energy resolution, expressed as a percentage of full width at half maximum (FWHM), typically improves as the deposited energy increases. The specific shape and values are illustrative and not limiting, and the method is applicable across a wide range of energies and detector configurations.

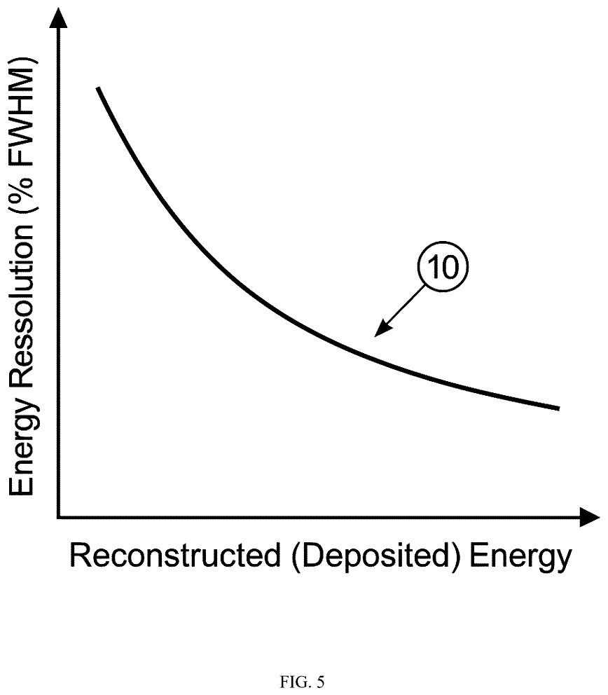

### DETAILED DESCRIPTION OF THE INVENTION

### System Overview

The system comprises a scintillator material, one or more wavelength-resolving photodetectors, and a processing unit. The photodetectors record individual photon detections, including wavelength. As used herein, wavelength-resolving photodetector refers to a device or system capable of assigning to each detected photon a wavelength estimate with finite and practically useful resolution, sufficient to distinguish event-specific spectral variations. This excludes detectors or systems whose wavelength determination uncertainty is on the order of or otherwise substantial relative to their overall spectral sensitivity range, such that no meaningful spectral discrimination can be made on a photon-by-photon basis. Timing and positional data may also be recorded, but are standard in the art and not part of the claimed novelty.

### Method Embodiment

1. Photon Detection: Photons generated in response to an energy deposition event are detected by the photodetectors. For each photon, a wavelength measurement is recorded, thereby constructing an event-specific spectral response. Timing and positional information may also be recorded, but are considered conventional in the art.
2. Calibration: Known sources are used to obtain calibrated spectral responses for one or more defined energies. Sources of known energy deposition suitable for obtaining calibrated spectral responses may include, without limitation, radioactive isotopes that emit particles or radiation with characterized energy distributions, or controlled-energy radiation beams such as electron, proton, neutron, gamma, or X-ray beams. The specific choice of source is not critical to the practice of the invention. A person skilled in the art will recognize that any source capable of depositing a known amount of energy in the scintillator may be used to establish calibration spectral responses.
3. Simulation: Monte Carlo modeling is employed to generate simulated spectral responses, incorporating the full chain of relevant physical processes, including energy deposition and the resulting photon generation, photon transport, re-emission, absorption, and detector response effects. Suitable simulation frameworks include, without limitation, the Geant4 toolkit, FLUKA, MCNP, or other equivalent or future-developed particle and photon transport models capable of representing these processes. The simulated responses are adjusted to match the calibrated responses within measurement uncertainties.
4. Reference Schema: The calibrated and simulated spectral responses are assembled into an ensemble of reference spectra, herein referred to as a reference schema. Each element of the schema may correspond to a different known or simulated deposited energy and may include uncertainties.
5. Energy Estimation: The observed spectral response of an event is compared to the reference schema using statistical or computational analysis. Suitable approaches include, without limitation, functional fitting, regression methods, interpolation, extrapolation, or machine learning algorithms such as artificial neural networks. The outcome of this comparison provides an estimate of the amount of energy deposited in the scintillator for the event being analyzed.

### System Embodiment

The foregoing method may be implemented within a detector system comprising a scintillator material, wavelength-resolving photodetectors, and a processing unit configured to perform the described analytical and computational operations. The system elements correspond to those recited in the system claims and may be realized in various hardware and software architectures without departing from the scope of the invention.

### Alternative Embodiments

Spectral Descriptors: Instead of wavelength, photon energy, frequency, or a discrete color index may be used as equivalent spectral descriptors for constructing the spectral response.
Joint Use of Data: Wavelength-based analysis may be combined with timing and positional information to refine corrections for various experimental effects, including, without limitation, chromatic dispersion, depth-of-interaction, or non-uniform light transport. Timing and positional data are considered conventional in scintillator detectors, but their combined use with per-photon wavelength information can provide enhanced performance in certain applications.

It should be understood that recording and using timing and positional information of detected photons for corrections related to photon transport, depth-of-interaction, or event localization is well established in the art. The present disclosure instead focuses on the additional use of per-photon wavelength information in calibration, schema construction, and energy reconstruction, which distinguishes the disclosed methods from conventional approaches.
Computational Approaches: Energy estimation may employ advanced computational tools, including but not limited to machine learning algorithms, ensemble methods, or other artificial intelligence techniques that make use of wavelength data alone or in combination with timing and positional features.
Detector Architectures: The invention is compatible with a wide range of scintillator detector geometries, including, by way of example, monolithic scintillators, segmented arrays, and large-volume liquid scintillators. It may be applied, without limitation, to diverse experimental and practical contexts such as neutrino detection, double-beta decay searches, positron emission tomography (PET), radiation monitoring, or other applications benefiting from energy measurement.
Calibration Flexibility: Calibration may be performed at one or more reference energies using different types of sources, and interpolation or extrapolation between these reference points may be used to build a continuous or discretized calibration space within the reference schema.

### Advantages

By incorporating wavelength information into the reconstruction process, the invention mitigates systematic errors that arise from wavelength-dependent photon transport, self-absorption, re-emission, and variations in overall detector response. This enables energy resolution that approaches the statistical limit imposed by photon counting, by reducing or eliminating systematic contributions that otherwise degrade performance in conventional methods. The invention therefore allows more accurate and reliable energy measurement in scintillator detectors, even when timing and positional data are also recorded and used for auxiliary corrections.

### Implementation Note

Practical photodetectors capable of resolving the wavelength of individual photons are not yet standard in scintillator detector systems. However, their development is an active area of research. For example:
Young, Sarovar, and Léonard, “Nanoscale architecture for frequency-resolving single-photon detectors,” Communications Physics, vol. 6, Article 71, 2023.
CPAD 2019—early discussions of detector architectures relevant to the simultaneous measurement of photon wavelength and arrival time, including potential applications involving scintillation-based photon detection.

Exploratory work in the community prior to CPAD 2019, and continuing thereafter, focused primarily on correcting chromatic dispersion effects in scintillator and water-Cherenkov detector systems. These efforts, including early discussions at CPAD 2019, examined photodetector architectures capable of using both timing and wavelength information on a per-photon basis to improve event-vertex reconstruction and to refine the geometric topology reconstruction of charged-particle tracks associated with the event, but not for the purpose of enhancing energy resolution in scintillator detectors. In contrast, the present invention utilizes per-photon wavelength information in a novel manner, by constructing calibrated and simulated reference spectral responses and employing them for event-by-event energy estimation. This represents a departure from conventional approaches that rely on total photon counts, timing and positional corrections, or bulk spectral averages, by instead exploiting the detailed, event-specific spectral shape.

1. A method for determining an amount of energy deposited in a scintillator detector, the method comprising:
detecting photons emitted in response to an energy deposition event in the scintillator;
recording, for each detected photon, a wavelength measurement, thereby constructing an observed spectral response that comprises photon counts, photon wavelengths, and associated uncertainties;
generating one or more reference spectral responses corresponding to known energy depositions, the reference spectral responses comprising calibrated spectral responses obtained from experimental calibration and/or simulated spectral responses obtained from a simulation model representing the relevant physical processes;
adjusting the simulated spectral responses to be consistent with the calibrated spectral responses within associated measurement and modeling uncertainties;
storing the calibrated and simulated spectral responses as a reference schema; and
comparing the observed spectral response of the event to the reference schema using a statistical or computational analysis, and inferring from said comparison the amount of energy deposited in the scintillator.

2. The method of claim 1, further comprising recording timing and positional information for detected photons for which such information is available, wherein analyzing the observed spectral response comprises jointly evaluating wavelength, timing, and positional distributions to apply corrections for, by way of example, chromatic dispersion, photon transport, depth-of-interaction, or other relevant effects.

3. The method of claim 1 or 2, wherein wavelength measurements are available for only a portion of the detected photons or detector channels, and the comparison between the observed spectral response and the reference schema is performed in conjunction with data obtained from other photodetectors that do not provide wavelength information.

4. The method of any one of claims 1 through 3, wherein timing and positional data, if available, are employed to refine the reference schema before comparison with observed spectral responses.

5. The method of any one of claims 1 through 3, wherein the statistical or computational analysis comprises a joint fit of photon wavelength distributions together with timing and positional information, if available, to the reference schema.

6. The method of any one of claims 1 through 3, wherein the statistical or computational analysis comprises use of a machine learning algorithm trained on photon wavelength data together with timing and positional features, if available, of detected photons.

7. The method of any one of claims 1 through 6, wherein the spectral response is constructed using photon energy, photon frequency, or a color index in place of wavelength.

8. A system for determining an amount of energy deposited in a scintillator detector, the system comprising:
a scintillator material configured to emit photons in response to an energy deposition event;
one or more photodetectors optically coupled to the scintillator material, the one or more photodetectors being configured to detect individual photons and to record, for each detected photon, a wavelength measurement; and
a processing unit configured to:
construct an observed spectral response from the recorded photon wavelength data;
generate reference spectral responses corresponding to known energy depositions, the reference spectral responses comprising calibrated spectral responses obtained from experimental calibration and/or simulated spectral responses obtained from modeling;
adjust the simulated spectral responses to be consistent with the calibrated spectral responses within associated measurement and modeling uncertainties;
store the calibrated and simulated spectral responses as a reference schema; and
compare the observed spectral response of an event to the reference schema using a statistical or computational analysis, and infer from said comparison the amount of energy deposited in the scintillator.

9. The system of claim 8, wherein the one or more photodetectors are further configured to record timing and positional information for detected photons for which such information is available, and wherein the processing unit is configured to jointly evaluate wavelength, timing, and positional data to apply corrections for, by way of example, chromatic dispersion, photon transport, depth-of-interaction, or other relevant effects.

10. The system of claim 8 or 9, wherein wavelength measurements are available for only a portion of the detected photons or detector channels, and the processing unit is configured to perform the comparison between the observed spectral response and the reference schema in conjunction with data obtained from other photodetectors that do not provide wavelength information.

11. The system of any one of claims 8 through 10, wherein the processing unit is configured to employ timing and positional data, if available, to refine the reference schema before comparison with observed spectral responses.

12. The system of any one of claims 8 through 10, wherein the processing unit is configured to perform a joint statistical fit of photon wavelength distributions together with timing and positional information, if available, to the reference schema.

13. The system of any one of claims 8 through 10, wherein the processing unit is configured to execute a machine-learning model trained on photon wavelength data together with timing and positional features, if available, of detected photons.

14. The system of any one of claims 8 through 13, wherein the observed spectral response is constructed using photon energy, photon frequency, or a color index in place of wavelength.
